(19) United States
(12) Patent Application Publication
(10) Pub. No.: US 2018/0086662 A1
(43) Pub. Date: Mar. 29, 2018

(54) PROCESS FOR FORMING TEXTURED GLASS COMPONENT WITH HIGH BENDING STRENGTH

(71) Applicant: Apple Inc., Cupertino, CA (US)

(72) Inventors: Victor Luzzato, Santa Clara, CA (US); Jeffrey C. Mylvaganam, Santa Clara, CA (US); Christopher C. Bartlow, Menlo Park, CA (US)

(21) Appl. No.: 15/712,746

(22) Filed: Sep. 22, 2017

Related U.S. Application Data
(60) Provisional application No. 62/399,161, filed on Sep. 23, 2016.
(60) Provisional application No. 62/399,128, filed on Sep. 23, 2016.

(51) Int. Cl. C03C 15/00; C03C 21/00; C03C 19/00; C03B 25/02

(52) U.S. Cl. CPC C03C 15/00; C03B 25/025; C03C 19/00; C03C 21/002

(57) ABSTRACT

A method of processing a glass substrate including texturing the glass substrate to form a textured surface that includes a plurality of micro fractures extending from the textured surface into the substrate. And, thereafter, chemically etching the textured surface of the glass substrate to a depth sufficient to remove the micro fractures. The glass substrate can then be chemically strengthened after the etching step.

### CROSS-REFERENCES TO RELATED APPLICATIONS

This application claims the benefit of U.S. provisional patent application Nos. 62/399,161 entitled “HAZY GLASS TEXTURES WITH HIGH BENDING STRENGTHS” and 62/399,128 entitled “REDUCED OFFSET FOR TEXTURED TO POLISHED TRANSITIONS ON GLASS MATERIALS USING MECHANICAL ABRASION TEXTURING” each of which was filed Sep. 23, 2016, and each of which is hereby incorporated by reference in its entirety.

### BACKGROUND

Textured glass components are often used in consumer electronics, but the texturing process can degrade the strength of the component by generating subsurface damage. This is especially true for textures generated by mechanical abrasion processes (e.g., sandblasting, lapping), which have the benefit of generating rough, hazy textures. Additionally, transitions from a polished to a textured finish in such textured glass components can often include a physical step offset that can become an area of stress concentration and that can feel rough and uneven to the touch.

In view of these and other deficiencies in commonly used glass texturing processes, new and improved methods of texturing glass components are desirable.

### BRIEF SUMMARY

Embodiments of the disclosure pertain to processes and techniques for texturing glass and to the glass components that are made according to such processes. Various embodiments of the disclosure provide improved processes that can generate high strength textured glass parts, and/or improved techniques for forming high bend strength glass substrates with improved topography at the transition between textured and polished surfaces. In some embodiments textured glass parts produced according to the techniques and methods disclosed herein can be used in electronic devices, such as laptop or desktop computers, accessory electronic devices, smart phones, tablet computers, and similar devices. The described techniques and methods are not limited to producing textured glass parts or components for any particular type of device however, and in other embodiments, textured glass parts produced according to the techniques and method disclosed herein can be used in other types of devices.

In some embodiments a method of processing a glass substrate is provided. The method includes texturing the glass substrate to form a textured surface, the textured surface including a plurality of micro fractures extending from the textured surface into the substrate; and thereafter, chemically etching the textured surface of the glass substrate to a depth sufficient to remove the micro fractures. The glass substrate can then be chemically strengthened after the etching step.

In some embodiments a method of processing a glass substrate is provided that includes: strengthening the glass substrate using either a thermal tempering or chemical strengthening process; texturing the strengthened glass substrate to form a textured surface; and thereafter, chemically strengthening the glass substrate.

In some embodiments a method of processing a glass substrate is provided that includes: texturing the glass substrate to form a textured surface; annealing the textured surface of the glass substrate; and thereafter, chemically strengthening the glass substrate.

In some instances of each of the disclosed methods, the texturing step can include a sandblasting process. In some instances of each of the disclosed methods the chemically strengthening step can be an ion exchange process, such as a process in which the glass substrate is submersed in a bath containing a potassium salt where sodium ions in the glass substrate are replaced by potassium ions from the bath solution.

According to some embodiments that can form areas of texture in a glass substrate with a minimal step difference between the textured and polished surfaces, the method includes protecting one or more glass substrate areas that are to remain polished with a protective coating material, mechanically generating the texture (e.g., by sandblasting or lapping), removing the protective coating material, and etching the glass substrate to uniformly remove glass material until the subsurface damage is removed. Such embodiments can significantly reduce step transitions from textured to polished surfaces on glass substrates while maintaining a high bend strength.

In accordance with some embodiments, a method of forming a textured glass substrate is provided. The method includes forming a protective material on a surface of the glass substrate, texturing the exposed surface areas of the glass substrate, removing the protective material to expose the underlying surface area, the underlying surface area forming a remaining polished surface area, and uniformly etching the textured surface areas and the remaining polished surface area.

In some embodiments, the method further includes strengthening the glass substrate after the etching step, and/or carrying out the etching step so as to eliminate micro-fractures extending from the textured surface areas into the glass substrate. In some other embodiments, after the etching step, the remaining polished surface area is elevated relative to the textured surface areas by less than 5 microns.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

FIG. 1 is a flowchart depicting steps associated with texturing a glass substrate according to a previously known method;

FIG. 2 illustrates subsurface damage that can be present in a glass substrate textured according to the method shown in FIG. 1;

FIG. 3 is a flowchart depicting steps associated with texturing a glass substrate according to an embodiment of the present disclosure;

FIG. 4 illustrates removal of subsurface damage present in a glass substrate textured according to the method shown in FIG. 3;

FIG. 5 is a graph plotting strength data of a polished (untextured) glass sample, a glass sample textured according to the method of FIG. 1 and a glass sample textured according to the method of FIG. 3;

FIG. 6 is a flowchart depicting steps associated with texturing a glass substrate according to an embodiment of the present disclosure;

FIG. 7 is a graph plotting failure load distribution data of a polished (untextured) glass sample, a glass sample textured according to previously known methods and a glass sample textured according to the method of FIG. 6;

FIG. 8 is a flowchart depicting steps associated with texturing a glass substrate according to an embodiment of the present disclosure;

FIGS. 9A-9E are simplified cross-section views (upper images) and corresponding top views (lower images) illustrating a process flow for forming textured glass substrates according to embodiments of the present disclosure;

FIG. 10 is a flowchart depicting process steps employed to form the textured glass substrates shown in FIGS. 9A-9E;

FIG. 11 is a graph depicting the scanned topography of a sample glass substrates textured according to a previously known process;

FIG. 12 is a graph depicting the scanned topography of a sample glass substrates textured according to the process set forth in FIG. 10;

FIG. 13 is a flowchart depicting steps associated with texturing a glass substrate according to an embodiment of the present disclosure; and

FIG. 14 is a flowchart depicting steps associated with texturing a glass substrate according to an embodiment of the present disclosure.

### DETAILED DESCRIPTION

Embodiments of the disclosure pertain to processes and techniques for texturing glass and to the glass components that are made according to such processes. As stated above, various embodiments of the disclosure provide improved processes and techniques that can generate high strength textured glass parts, and/or improved processes and techniques for forming high bend strength glass substrates with improved topography (e.g., offset transitions of less than 5 μm) at the transition between textured and polished surfaces. In some embodiments textured glass parts produced according to the techniques and methods disclosed herein can be used in electronic devices, such as laptop or desktop computers, accessory electronic devices, smart phones, tablet computers, and similar devices. The described techniques and methods are not limited to producing textured glass parts or components for any particular type of device however, and in other embodiments, textured glass parts produced according to the techniques and method disclosed herein can be used in other types of devices.

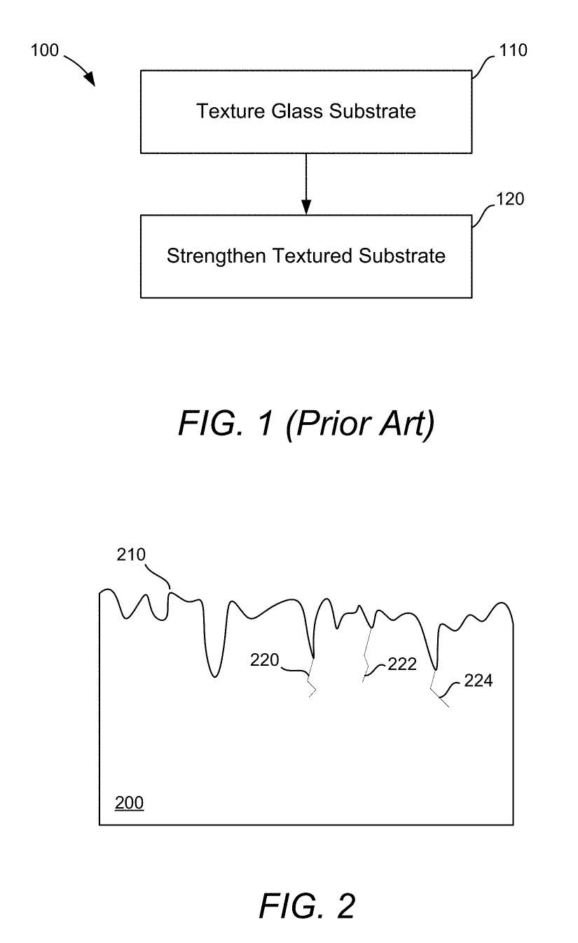

In order to better understand and appreciate the advantages and benefits of embodiments of the present disclosure, reference is first made to FIGS. 1 and 2 where FIG. 1 is a flowchart depicting steps associated with texturing a glass part according to a previously known method 100 and FIG. 2 is a simplified cross-sectional view of a glass substrate 200 having damage incurred at the substrate surface as a result of being textured according to method 100. In method 100 a glass substrate, such as substrate 200, or other glass sample is textured according to any of a variety of known texturing techniques (step 110). For example, step 110 can texture a surface of glass substrate 200 by subjecting the glass substrate to a sandblasting process, a lapping process, a photolithography and plasma etch process, a chemical etching process or a thermal-mechanical imprinting process. After the texturing process, glass substrate 200 includes a textured surface 210 having peaks and valleys that determine the surface roughness as shown in FIG. 2. The texture of surface 210 can generally be controlled to within a desired roughness range by selecting appropriate parameters of the texturing process.

The texturing process generally weakens the glass substrate and it is common to chemically strengthen the surface of substrate (step 120) using known techniques. As shown in FIG. 2, however, the texturing process can also create subsurface damage in the form of cracks 220, 222, 224 that generally extend from the textured surface into the substrate. Some of cracks 220, 222 and 224 can extend far enough below the textured surface 210 of glass substrate 200 (e.g., 20 microns, 30 microns or more below the substrate surface) that the cracks extend below the strengthened area of the substrate. Such cracks can be a source of failure of the glass substrate when the substrate is exposed to a potentially damaging source (e.g., dropping an electronic device having a component that includes the textured surface or having an object impact the textured surface).

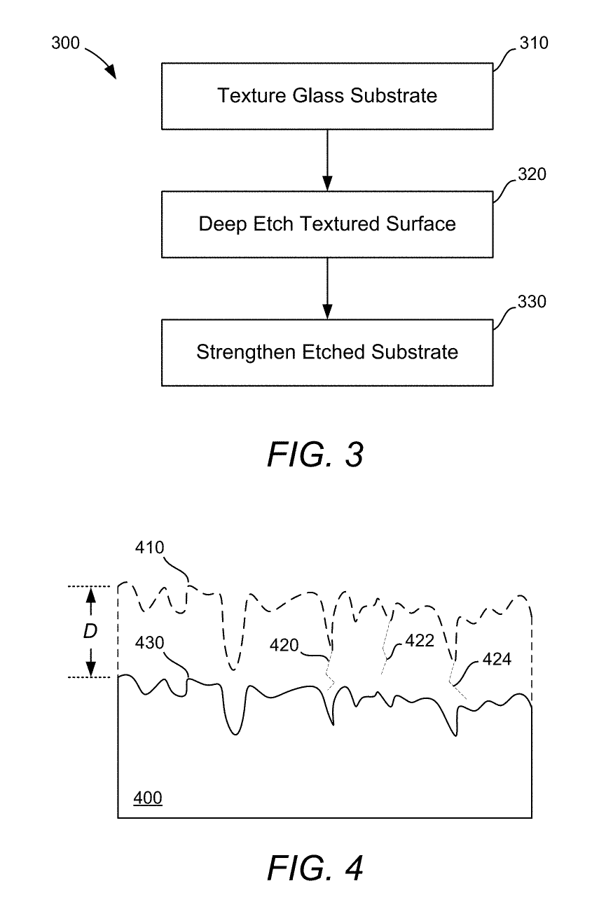

Some embodiments of the disclosure process the glass substrate to remove the subsurface damage prior to a strengthening process. FIG. 3 is a flowchart depicting steps associated with a method 300 of texturing a glass part according to one such embodiment; and FIG. 4 is a simplified cross-sectional view of a glass substrate 400 in which subsurface damage at the surface of the substrate from a texturing process has been removed according to the method shown in FIG. 3. As shown in FIG. 3, method 300 includes texturing a surface of a glass substrate (step 310) using any appropriate texturing technique as described with respect to FIG. 1. Referring to FIG. 4, after the texturing process the textured substrate 400 has a textured surface 410 that includes subsurface damage 420, 422, 424 just as surface 210 of substrate 200 included subsurface damage 220, 222 and 224.

Prior to strengthening substrate 400, however, method 300 exposes the textured substrate to a deep chemical etch step (step 320) in which the substrate is submersed in a bath of a liquid etchant known to etch glass material. Examples of suitable etchants include, but are not limited to, hydrofluoric acid (HF), sodium hydroxide (NaOH), potassium hydroxide (KOH), and phosphoric acid (H₃PO₄). Deep etch step 320 etches substrate 400 to a sufficient depth, D, into the textured glass substrate 400 such that the newly etched surface 430 of the glass substrate is below the depth of subsurface damage 420, 422, 424.

According to some embodiments, the depth, D, at which step 320 etches substrate 400 can be predetermined based upon empirical results from past tests and experiments on similar substrates. For example, for any given texturing step on a particular type of glass substrate, a batch of substrates can be textured according to the parameters of the texturing step and then tested and examined under a microscope to determine the extent of the subsurface damage including the depth of cracks that have been formed. The parameters of chemical etch step 320 (e.g., the type of etchant and the length of time the substrate is exposed to the etchant bath) can be selected based on this statistical data to ensure that enough glass is etched away to remove the subsurface damage of substrates processed in the future according to the particular texturing process.

After deep etch step 320, the etched and textured glass substrate can be chemically strengthened (step 330) by, for example, an ion exchange process. As one example, step 330 can strengthen the textured glass substrate by submersing the substrate in a bath containing a molten salt (e.g., a potassium salt) having ions that are larger than the sodium ions in the glass substrate. In the ion exchange process, the sodium ions in the glass surface are replaced by the larger ions (e.g., potassium ions) from the bath solution. Since the larger ions are larger than the sodium ions, the larger ions wedge themselves into the gaps left by the smaller sodium ions when the sodium ions migrate from the glass substrate into the potassium solution. This replacement of ions causes the surface of the glass substrate to be in a state of compression and the core of the glass substrate to be in compensating tension resulting in a strengthened glass component.

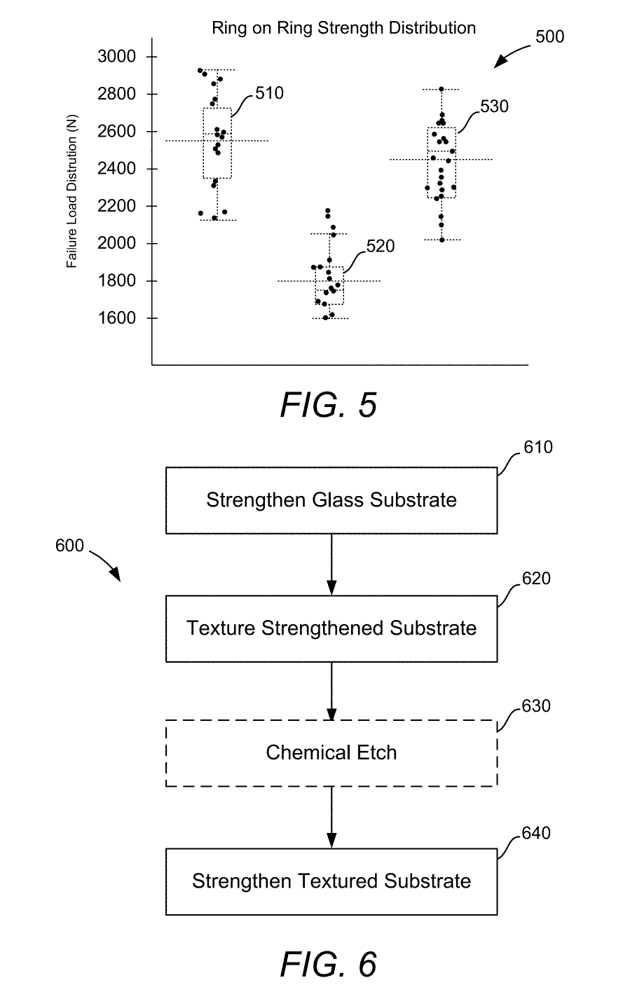

FIG. 5 is a graph 500 plotting strength data of polished (untextured) glass substrates (data set 510), glass substrates textured according to the method of FIG. 1 (data set 520) and glass substrates textured according to the method of FIG. 3 (data set 530). The strength data depicted in FIG. 5 measures failure loads of glass substrates in each data set under the same ring-on-ring strength distribution testing method. As evident from the data depicted in FIG. 5, glass substrates textured according to the techniques of the present disclosure as set forth in FIG. 3 exhibit strength characteristics close to the strength of polished (untextured) glass substrates and exhibit considerably higher strength characteristics than glass substrates textured according to the previously known texturing process depicted in FIG. 1.

FIG. 6 is a flowchart depicting steps associated with a method 600 of texturing a glass substrate according to another embodiment of the present disclosure. Method 600 subjects a glass substrate to a strengthening step (step 610) prior to the texturing process. The strengthening step forms a compressive layer at the surface of the glass substrate that subsequently limits the amount of subsurface damage generated when the glass substrate is textured (step 620). In some embodiments strengthening step 610 is a thermal tempering process in which the glass is heated and then rapidly cooled. In other embodiments strengthening step 610 is a ion exchange process as described above with respect to FIG. 3, step 330.

After the initial strengthening step 610, the strengthened glass substrate is then textured (step 620) by, using for example, a sandblasting or lapping texture process. During the texturing step, the substrate surface is weakened somewhat but the strengthened surface of the glass substrate is more resistant to the formation of subsurface damage than the unstrengthened surface which thereby minimizes the formation of cracks, such as cracks 220, 222 and 224 shown in FIG. 2 and minimizes the depth of such cracks.

Once textured, the textured glass substrate can be subjected to a second strengthening step to strengthen the weakened surface (step 640). Because step 610 minimized and contained subsurface damage caused by step 620 to relatively shallow cracks, in many instances strengthening step 640 can strengthen the glass substrate to a depth below the subsurface damage. In some embodiments, however, an etch step 630 similar to step 320 can be employed between steps 620 and 640 to completely remove the subsurface before strengthening step 640. Because any subsurface damage imparted to the glass substrate during step 620 is likely to be less than (e.g., shallower cracks) the damage present in a textured glass substrate that was not strengthened prior to the texturing step. Thus, if employed between steps 620 and 640, etch step 630 can often be used with parameters (etchant type, etchant concentration, temperature, duration, etc.) that are able to successfully remove such damage using a shallower etch than if step 610 was not employed.

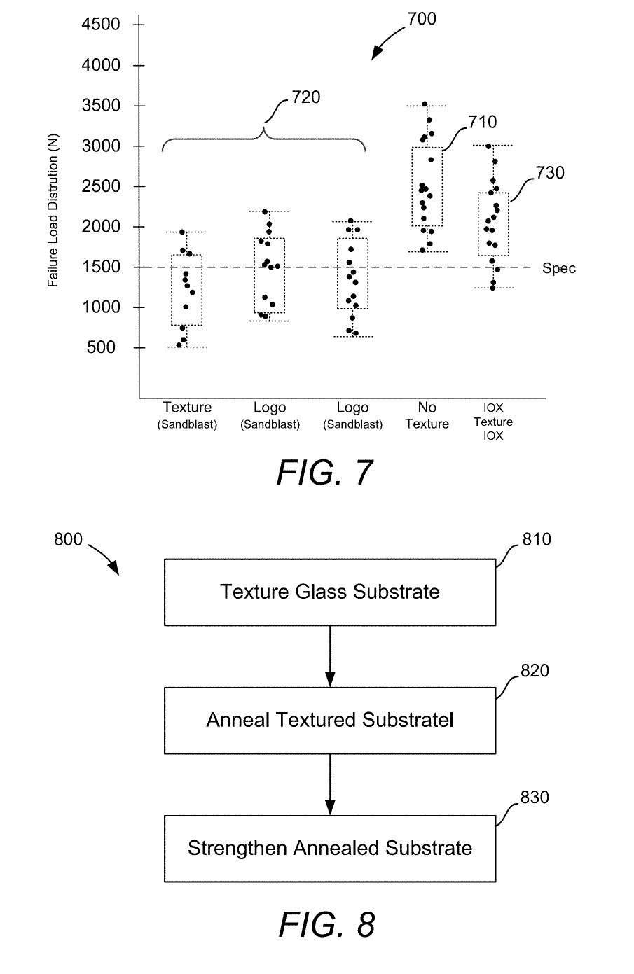

FIG. 7 is a graph plotting failure load distribution data of polished (untextured) glass substrates (data set 710), glass substrates textured according to previously known methods depicted in FIG. 1 (data sets 720), and glass substrates textured according to the method of FIG. 6 (data sets 730). The failure data depicted in FIG. 7 measures failure loads of glass substrates in each data set under the same ring-on-ring strength distribution testing method. As evident from the data depicted in FIG. 7, glass substrates textured according to the techniques of the present disclosure as set forth in FIG. 6 exhibit strength characteristics close to the strength of polished (untextured) glass substrates and exhibit considerably higher strength characteristics than glass substrates textured according to the previously known texturing process depicted in FIG. 1.

FIG. 8 is a flowchart depicting steps associated with method 800 of texturing a glass substrate according to another embodiment of the present disclosure. Method 800 includes texturing a surface of a glass substrate (step 810) using a mechanical texturing process, such as a sandblasting process, a lapping process or a thermal-mechanical imprint process. After the glass substrate is textured, the substrate is exposed to an annealing process (step 820) in which the glass substrate is heated to its annealing temperature. The annealing process melts subsurface damage at or near the surface of the substrate in the textured region and reduces stress near the surface of the textured region. Then, after the annealing process, the textured glass substrate can be subjected to a strengthening step to strengthen the textured surface (step 830) using a glass strengthening techniques such as that described above with respect to FIG. 3, step 330.

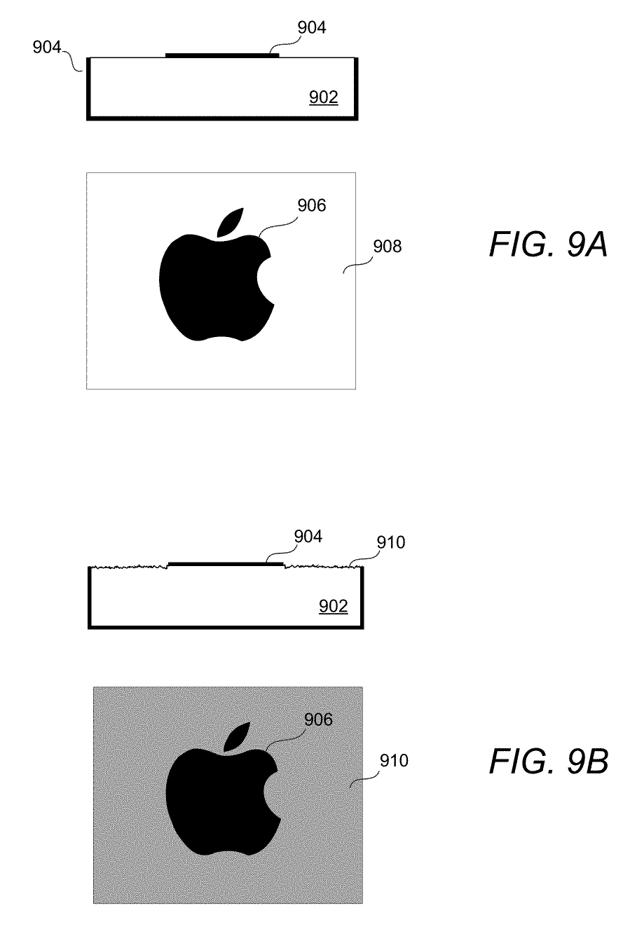

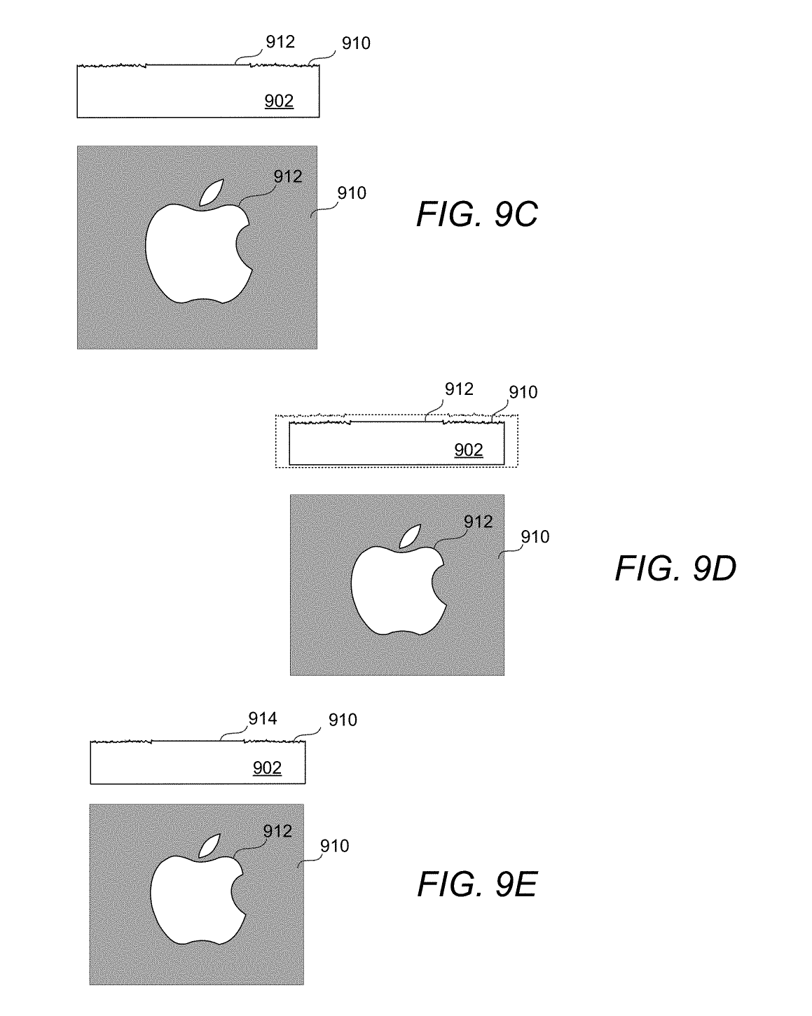

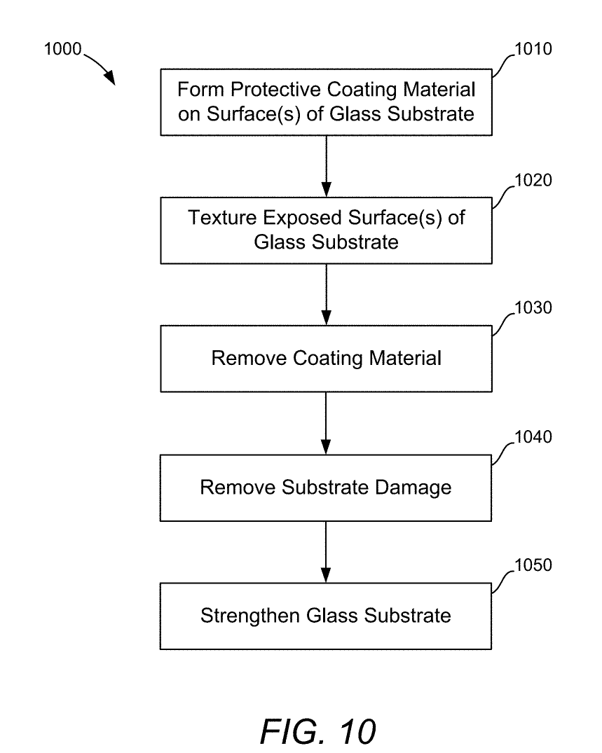

Reference is now made to FIGS. 9A-9E and FIG. 10 in order to better understand and appreciate the advantages and benefits of additional embodiments of the present disclosure that can be employed to form one or more textured regions at a surface of a glass substrate where the transition between the textured region(s) and adjacent polished region(s) has a reduced step height as compared to conventional texturing techniques. FIGS. 9A-9E are simplified cross-sectional views (upper images) and corresponding top views (lower images) of a glass component 902 as the component is processed according to the flow chart depicted in FIG. 10, which sets forth steps associated with forming a reduced transition offset from a textured surface to a polished surface in a glass component according so some embodiments of the disclosure. As shown in FIG. 9A and depicted by step 1010 in FIG. 10, one or more surface areas of glass substrate 902 may be covered with protective coating material 904, such as protective ink. Surface areas covered with protective coating material 904 correspond to surface areas of glass substrate 902 that are to remain polished. In the lower image (top view) in FIG. 9A, darker area 906 corresponds to the surface area that is to remain polished (i.e., is covered by protective coating material 904), and the remaining lighter area 908 is to be textured in later steps. While the images in FIG. 9A show a portion of the top surface and all of the bottom and side surfaces of glass substrate 902 being covered by protective coating material 904, the embodiments disclosed herein are not limited as such. In some embodiments, protective coating material 904 is formed using known techniques, such as, depositing, defining and etching a coating material to form regions 904.

Next, as shown in FIG. 9B and depicted by step 1020 in FIG. 10, surface areas of glass substrate 902 not covered by protective coating material 904 are textured. In the lower image in FIG. 9B, darker area 906 corresponds to the polished area, and the remaining lighter area 910 corresponds to the textured surfaces. Texturing of the exposed surface areas 910 may be achieved by subjecting glass substrate 902 to a sandblasting process, a lapping process, a photolithography and plasma etching process, a chemical etching process or a thermo-mechanical imprinting process. After the texturing process, glass substrate 902 includes textured surface areas 910 having peaks and valleys that dictate the surface roughness. The texture of surface 910 can generally be controlled to within a desired roughness range by selecting appropriate parameters of the texturing process. During the texturing process, surface areas covered by coating material 904 are protected and thus remain polished.

Next, as shown in FIG. 9C and depicted by step 1030 in FIG. 10, protective coating material 904 is removed using known techniques. In the lower image in FIG. 9C, lighter area 912 corresponds to the polished surfaces, and the remaining darker area 910 corresponds to the textured surfaces. As will become more clear further below, this step advantageously eliminates the height differential between polished and textured surfaces that would be otherwise be present if coating material 904 were not removed prior to etch step 1040, described next.

The texturing process generally weakens glass substrate 902 and it is common to chemically strengthen the surface of substrate using known techniques. However, as discussed above, the texturing process can create subsurface damage in the form of cracks that generally extend from the textured surface into the substrate. Some of the cracks can extend far enough below the textured surface of glass substrate 902 (e.g., 20 μm, 30 μm or more below the substrate surface) that the cracks extend below the strengthened area of the substrate. Such cracks can be a source of failure of the glass substrate when the substrate is stressed (e.g., by dropping a smart phone that has a textured glass substrate).

As shown in FIG. 9D and depicted by step 1040 in FIG. 10, one or more process steps may be carried to remove subsurface substrate damage caused by the texturing step and/or other prior process steps. In some embodiments, glass substrate 902 is chemically etched to uniformly remove sufficient glass material until the subsurface damage, such as micro-fractures extending from the textured surface into the substrate, is removed. In some embodiments, a deep chemical etch is carried out (e.g., to remove 30 μm or more) so that the newly etched surface of the glass substrate is below the depth of subsurface damage. For any given texturing step on a particular type of glass substrate, the depth of subsurface damage that is expected to be formed can be measured by examining the substrate under a microscope. The parameters of chemical etch step 1040 (e.g., the type of etchant and the length of time the substrate is exposed to the etchant bath) can be selected to ensure that enough glass is etched away to remove the subsurface damage as described, for example, above with respect to FIG. 3, step 320. In the cross section view in FIG. 9D, the outer image (dotted lines) and the inner image of glass substrate 902 are intended to illustrate the reduction in the dimensions of glass substrate 902 that may occur due to the substrate etch. In the lower image in FIG. 9D, lighter area 914 corresponds to the polished surface areas, and the remaining darker area 916 corresponds to the textured surfaces.

Next, in FIG. 9E and as depicted by step 1050 in FIG. 10, the glass substrate is strengthened. In some embodiments, strengthening step 1010 is a thermal tempering process in which the glass substrate is heated and then rapidly cooled. In other embodiments, strengthening step 1010 is an ion exchange process as described above with respect to FIG. 3, step 330.

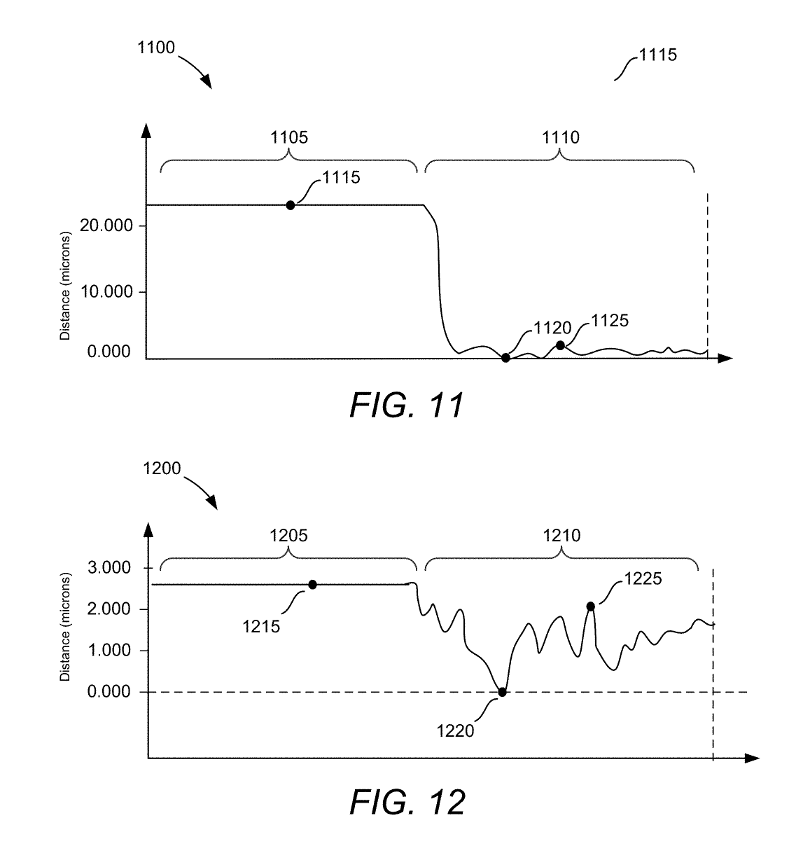

FIGS. 11 and 12 show graphs depicting the scanned topography of a two sample glass substrates. Graph 1100 in FIG. 11 illustrates the scanned topography for a sample glass substrate where the protective material was not removed prior to a chemical etch. Graph 1200 in FIG. 12 illustrates the scanned topography for a sample where the protective material was removed (step 1030) prior to the chemical etch (step 1040) in accordance with the method set forth in FIG. 10. Both graphs show the surface topography transitioning from a polished surface on the left (areas 1105 and 1205) to a textured surface on the right (areas 1110 and 1210). In FIG. 11, as can be seen, a step having a height in the range of 21.8 μm (the distance between points 1115 and 1125) to 23.6 μm (the distance between points 1115 and 1120) is formed at the transition between the polished and textured surfaces.

In contrast, in FIG. 12, which corresponds to the sample where the protective material is removed prior to the chemical etch, a substantially smaller step in the range of 0.8 μm (the distance between points 1215 and 1225) to 2.5 μm (the distance between points 1215 and 1220) is formed at the transition between the polished and textured surfaces. Thus, as can be seen, by removing the protective material prior to performing the chemical etch, the elevation difference between the polished surface and the textured surface can be substantially reduced, e.g., to less than 5 μm (as measured from the distance from the surface in area 1205 to the depth of the deepest valley in area 1210 in some embodiments or as measured from the distance from the surface in area 1205 to the mean depth between the valleys and peaks in area 1210 in some embodiments). This results in a much smoother feel when a finger runs across the transition between the polished and textured surfaces. The improved topography is achieved without sacrificing the glass bend strength since the chemical etch in step 1040 can be designed to remove as much of the surface material that is necessary to eliminate subsurface cracks without adversely impacting the topography as described above.

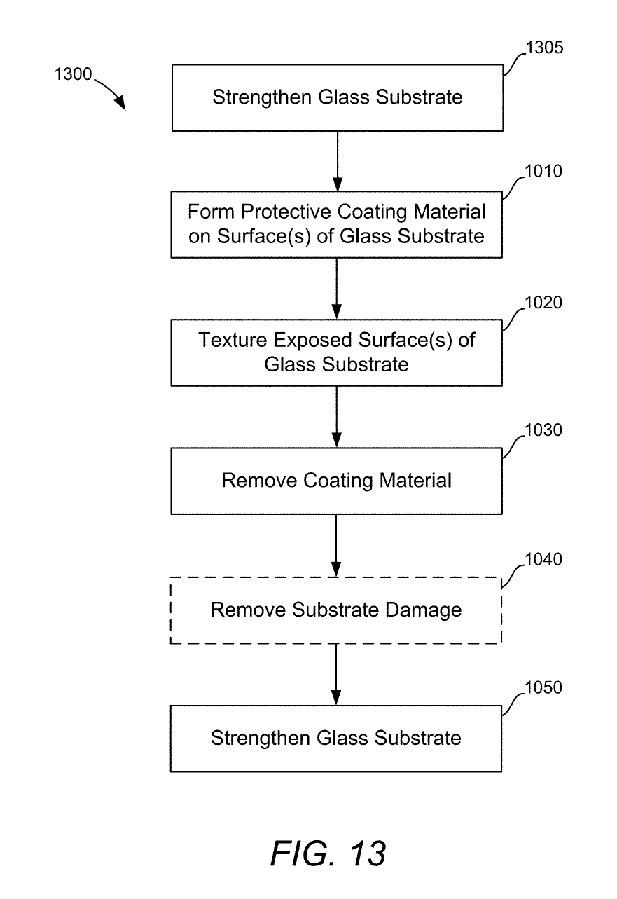

The method of forming a textured surface in a glass substrate having a reduced offset as set forth in FIG. 10 essentially incorporates the method of removing damage to the substrate from the texturing step with a deep etch step as discussed above with respect to FIG. 3. In other embodiments, the methods of FIG. 6 and FIG. 8 can be used in the formation of a reduced-offset textured surface on a glass substrate. For example, FIG. 13 is a flowchart depicting steps associated with forming a textured surface having a reduced-offset in a glass substrate according to a method 1300 that incorporates the method described above with respect to FIG. 6 to reduce substrate damage that might otherwise occur from the texturing step. As shown in FIG. 1, method 1300 strengthens the glass substrate (step 1305) using the techniques described above in FIG. 6, step 610 prior to forming a protective coating on the substrate that defines the untextured area.

After strengthening the substrate in step 1305, the glass substrate can be processed using the same sequence of steps 1010-1050 as described above with respect to FIG. 10. Performing strengthening step 1305 prior to texturing step 1020 can minimize and contain subsurface damage caused by step 1020 to relatively shallow cracks reduce. Thus, in some instances second strengthening step 1050 can strengthen the glass to a depth below the subsurface damage alleviating the need for step 1040. In other instances, however, etch step 1040 can be employed between steps 1020 and 1050 to completely remove the subsurface before strengthening step 1050.

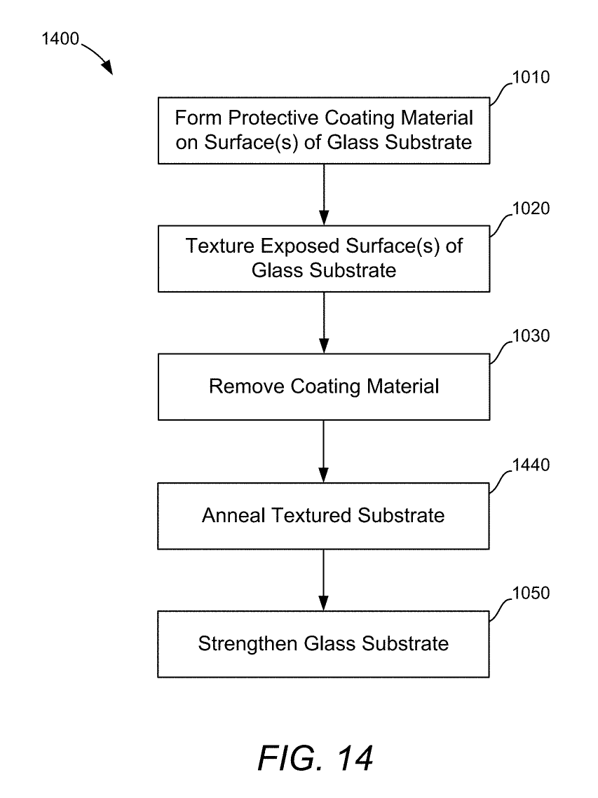

Referring to FIG. 14, in an embodiment depicted as method 1400 an anneal step can be used to repair the subsurface damage formed by the texturing step as described above with respect to FIG. 8. In method 1400 steps 1010, 1020, 1030 and 1050 as described with respect to FIG. 10 can all be employed. For example, as shown in FIG. 14 a protective coating (e.g., protective ink) can be applied to the surface of a glass substrate in the areas that are intended to remain polished (step 1010), and the substrate can then be subjected to a texturing process (e.g., sandblasting, lapping, etc.) where only the areas not covered by protective ink are textured (step 1020). The protective ink can then be removed (step 1030).

Prior to undergoing a second strengthening process (step 1050), the substrate can be annealed (step 1440) by heating the glass substrate to its annealing temperature as described above with respect to FIG. 8. The annealing process can repair subsurface damage incurred during the texturing step and can reduce stress near the surface of the textured region.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. The specific details of particular embodiments can be combined in any suitable manner without departing from the spirit and scope of embodiments of the invention. Additionally, spatially relative terms, such as “bottom or “top” and the like may be used to describe an element and/or feature's relationship to another element(s) and/or feature(s) as, for example, illustrated in the figures. It will be understood that the spatially relative terms are intended to encompass different orientations from the orientation depicted in the figures. For example, if an object in the figures is turned over, elements described with respect to a “bottom” of the object may then be oriented “above” other elements or features. The object can be otherwise oriented (e.g., rotated 90 degrees or at other orientations) and the spatially relative descriptors used herein interpreted accordingly.

What is claimed is:

1. A method of processing a glass substrate to form a textured surface on the substrate, the method comprising:
texturing the glass substrate to form a textured surface, the textured surface including a plurality of micro fractures extending from the textured surface into the substrate;
chemically etching the textured surface of the glass substrate to a depth sufficient to remove the micro fractures; and
thereafter, chemically strengthening the glass substrate.

2. The method of claim 1 wherein the chemically etching step comprises submersing the glass substrate in a bath of liquid etchant for a predetermined amount of time.

3. The method of claim 2 wherein the predetermined amount of time is determined based on statistical data from previously processed test substrates.

4. The method of claim 2 wherein the chemically strengthening step comprises an ion exchange process.

5. The method of claim 4 wherein ion exchange process includes submersing the glass substrate in a bath solution containing a potassium salt causing sodium ions in the glass substrate to be replaced by potassium ions from the bath solution.

6. The method of claim 1 wherein the texturing step comprises a sandblasting process.

7. The method of claim 1 further comprising the texturing step comprises a sandblasting process strengthening the glass substrate using either a thermal tempering or chemical strengthening process prior to the texturing process.

8. The method of claim 7 wherein the predetermined amount of time is determined based on statistical data from previously processed test substrates.

9. A method of processing a glass substrate to form a textured surface on the substrate, the method comprising:
strengthening the glass substrate using either a thermal tempering or chemical strengthening process;
texturing the glass substrate to form a textured surface; and
thereafter, chemically strengthening the glass substrate.

10. A method of processing a glass substrate to form a textured surface on the substrate, the method comprising:
texturing the glass substrate to form a textured surface;
annealing the textured surface of the glass substrate; and
thereafter, chemically strengthening the glass substrate.

11. A method of forming a textured glass substrate to form a textured surface on a portion of the substrate, the method comprising:
forming a protective material on a surface of a glass substrate;
texturing surface areas of the glass substrate not covered by the protective material;
removing the protective material to expose the underlying surface area, the underlying surface area forming a remaining polished surface area; and
etching the textured surface areas and the remaining polished surface area.

12. The method of claim 11 further comprising strengthening the glass substrate after the etching step.

13. The method of claim 12 wherein the strengthening step comprises an ion exchange process.

14. The method of claim 13 wherein ion exchange process includes submersing the glass substrate in a bath solution containing a potassium salt causing sodium ions in the glass substrate to be replaced by potassium ions from the bath solution.

15. The method of claim 12 further comprising strengthening the glass substrate prior to forming the protective material on a surface of a glass substrate.

16. The method of claim 11 wherein after the etching step, the remaining polished surface area is elevated relative to the textured surface areas by less than 5 microns.

17. The method of claim 11 wherein the textured surface areas are formed using one of sandblasting and lapping.

18. The method of claim 11 wherein the etching step is a uniform etching step carried out so as to eliminate micro-fractures extending from the textured surface areas into the glass substrate.

19. The method of claim 18 wherein the etching step comprises submersing the glass substrate in a bath of liquid etchant for a predetermined amount of time.

20. The method of claim 19 wherein the predetermined amount of time is determined based on statistical data from previously processed test substrates.
